(19) United States
(12) Patent Application Publication
(10) Pub. No.: US 2023/0091235 A1
(43) Pub. Date: Mar. 23, 2023

(54) INFORMATION PROCESSING APPARATUS AND INFORMATION PROCESSING METHOD

(71) Applicants: Satoshi HAGIWARA, Kanagawa (JP); Junichi TAKAMI, Kanagawa (JP); Yu TESHIMA, Kyoto (JP); Tomoki UMEZAWA, Kanagawa (JP); Gakushi MIYARA, Kanagawa (JP)

(72) Inventors: Satoshi HAGIWARA, Kanagawa (JP); Junichi TAKAMI, Kanagawa (JP); Yu TESHIMA, Kyoto (JP); Tomoki UMEZAWA, Kanagawa (JP); Gakushi MIYARA, Kanagawa (JP)

(21) Appl. No.: 17/908,919

(22) PCT Filed: Mar. 10, 2021
(86) PCT No.: PCT/IB2021/051972

§ 371 Date: Sep. 2, 2022

(30) Foreign Application Priority Data
Mar. 13, 2020 (JP) 2020-044095

(51) Int. Cl. G05B 19/418

(52) U.S. Cl. CPC G05B 19/4184; G05B 2219/31304

(57) ABSTRACT

An information processing apparatus includes a detection result acquisition unit to acquire, for each of processes performed on a plurality of workpieces, a detection result of a physical quantity that changes according to processing applied to a workpiece; an identification information acquisition unit to acquire process identification information identifying one of the processes performed on the same workpiece and workpiece identification information identifying one of the workpieces subjected to the same process; and a display control unit to display, on a display, the process identification information and the workpiece identification information; and display, on the display, abnormality likelihood information indicating likelihood of abnormality, determined based on the detection result, of the particular process or the particular workpiece, in association with at least one of the process identification information and the workpiece identification information.

### TECHNICAL FIELD

Aspects of the present disclosure relate to an information processing apparatus and an information processing method.

### BACKGROUND ART

PTL 1 discloses an abnormality analysis system that performs data analysis on detection results of detectors acquired via a fog network and determines an abnormality of each of a plurality of production facilities or an abnormality of a production target.

### CITATION LIST

### Patent Literature

[PTL 1]

Japanese Unexamined Patent Publication No. 2017-97839

[PTL 2]

### SUMMARY OF INVENTION

### Technical Problem

When a plurality of processes is performed on the same production target, or when the same process is performed on a plurality of production targets, it has been difficult to estimate which of the workpiece and processing has an abnormality, even with the above-described technology.

### Solution to Problem

In view of the foregoing, an object of the present disclosure is to provide an information processing apparatus and an information processing method capable of providing information for determining which of a workpiece and processing has an abnormality.

In order to achieve the above-described object, there is provided an information processing apparatus that includes a detection result acquisition unit, an identification information acquisition unit, and a display control unit. The detection result acquisition unit acquires, for each of a plurality of processes performed on a plurality of workpieces, a detection result of a physical quantity that changes according to processing applied to a workpiece. The identification information acquisition unit acquires process identification information identifying a particular one of the plurality of processes performed on the same workpiece and workpiece identification information identifying a particular one of the plurality of workpieces subjected to the same process. The display control unit displays, on a display, the process identification information and the workpiece identification information. The display control unit further displays, on the display, abnormality likelihood information indicating likelihood of abnormality, having been determined based on the detection result, of the particular process or the particular workpiece, in association with at least one of the process identification information and the workpiece identification information.

### Advantageous Effects of Invention

The present disclosure can provide the information processing apparatus and the information processing method capable of providing information for determining which of a workpiece and processing has an abnormality.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an example of a system configuration of an abnormality detection system according to an embodiment of the present disclosure.

FIG. 2 is a view illustrating a machine of the abnormality detection system illustrated in FIG. 1.

FIG. 3 is a block diagram illustrating an example of a hardware configuration of an information processing apparatus of the abnormality detection system illustrated in FIG. 1.

FIG. 4 is a block diagram illustrating an example of a hardware configuration of the machine illustrated in FIG. 2.

FIG. 5 is a block diagram illustrating an example of a functional configuration of the abnormality detection system illustrated in FIG. 1.

FIG. 6 is a block diagram illustrating an example of a detailed functional configuration of a signal processing unit illustrated in FIG. 5.

FIG. 7 is a sequence chart illustrating an example operation of acquiring a detection signal and displaying information, performed by the abnormality detection system illustrated in FIG. 1.

FIG. 8 is a conceptual diagram illustrating an example of a condition information management table.

FIG. 9 is a flowchart illustrating example operation of processing the detection signal performed by the information processing apparatus illustrated in FIG. 5.

FIG. 10A illustrates a spectrogram of the detection signal detected when the operation of the machine illustrated in FIGS. 2 and 4 is normal.

FIG. 10B illustrates a spectrogram of the detection signal detected when the operation of the machine illustrated in FIGS. 2 and 4 has an abnormality.

FIG. 11 is a conceptual diagram illustrating an example of a detection signal management table.

FIG. 12 is a conceptual diagram illustrating an example of a model information management table.

FIG. 13 is a diagram illustrating a first example of an information display screen displayed on the information processing apparatus illustrated in FIG. 5.

FIG. 14 is a diagram illustrating an example of display processing in the information processing apparatus illustrated in FIG. 5.

FIG. 15 is a diagram illustrating a second example of the information display screen displayed on the information processing apparatus illustrated in FIG. 5.

FIG. 16 is a diagram illustrating a third example of the information display screen displayed on the information processing apparatus illustrated in FIG. 5.

FIG. 17 is a diagram illustrating one example of an information display screen displayed on an information processing apparatus according to a first modification.

FIG. 18 is a diagram illustrating one example of an information display screen displayed on an information processing apparatus according to a second modification.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Hereafter, embodiments for implementing the present disclosure are described with reference to the drawings.

System Configuration

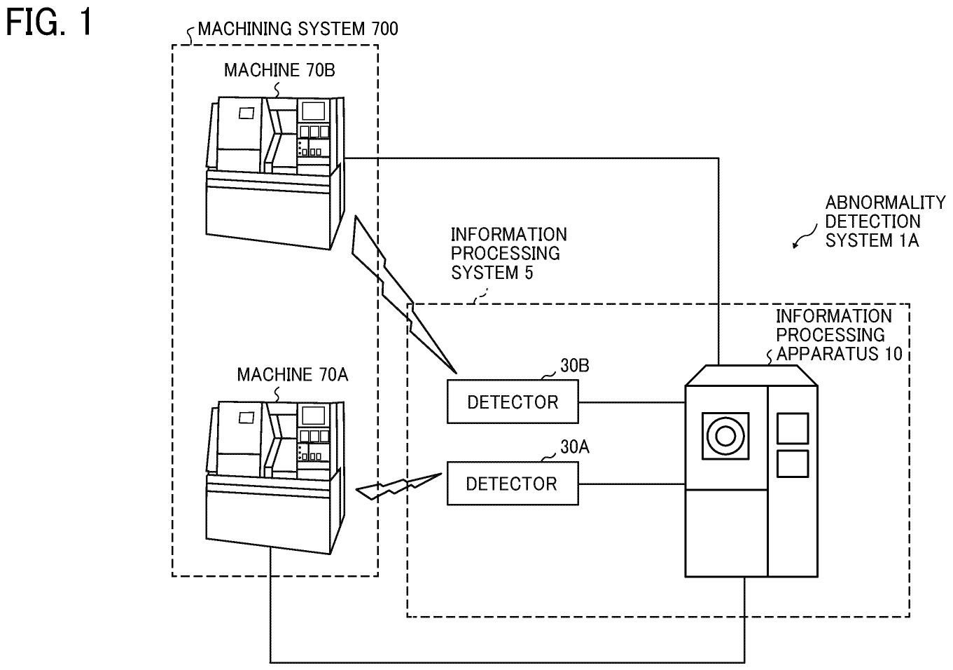

FIG. 1 is a diagram illustrating an example of a system configuration of an abnormality detection system according to the present embodiment.

An abnormality detection system 1A according to the present embodiment includes a machining system 700 as an example of a processing system, a first detector 30A, a second detector 30B, and an information processing apparatus 10.

The machining system 700 includes the first machine 70A and the second machine 70B. The first machine 70A and the second machine 70B are examples of a processing machine that performs machining (an example of processing) with a tool on a workpiece. The abnormality detection system 1A may include three or more machines 70 (processing machines) and include a plurality of detectors 30 corresponding to the plurality of machines 70.

The first detector 30A detects a physical quantity that change as the machine 70A processes the workpiece, and the second detector 30B detects a physical quantity that change as the machine 70B processes the workpiece.

Hereinafter, the “detector 30” is commonly used to refer to the first detector 30A and the second detector 30B unless the first detector 30A and the second detector 30B need to be distinguished from each other. Similarly, the “machine 70” is commonly used to refer to the first machine 70A and the second machine 70B unless the first machine 70A and the second machine 70B need to be distinguished from each other.

The information processing apparatus 10 is a diagnostic apparatus that is communicably connected to the machine 70 and diagnoses an abnormality in the operation of the machine 70. The information processing apparatus 10 may be a general-purpose personal computer (PC) in which a dedicated software program is installed. The information processing apparatus 10 may be a single computer or include a plurality of computers.

The information processing apparatus 10 and the machine 70 can be connected in any connection form. For example, the information processing apparatus 10 and the machine 70 may be connected by a dedicated connection line, a wired network such as a wired local area network (LAN), a wireless network, or the like.

The machine 70 is a machine tool that uses a tool to perform machining such as cutting, grinding, or polishing on a machining target (workpiece). The term “processing machine” is not limited to the machine tool and may refer to a machine capable of estimating an actual operating section that can be the target of diagnosis. For example, the processing machine may be an assembling machine, a measuring machine, an inspection machine, a washing machine, or the like. The term “processing machine” also refers to a machine that includes an engine (serving as a power source) including clutches, gears, etc., or a motor.

The detector 30 is a sensor that detects a physical quantity and outputs the detected physical quantity information as a detection signal (sensor data) to the information processing apparatus 10. The physical quantity detected is vibration, sound, or the like generated when the tool (such as a drill, end mill, cutting tool tip, or grindstone) installed in the machine 70 contacts the machining target during the processing, or vibration, sound, or the like generated by the tool or the machine 70 itself. The detector 30 includes, for example, a microphone, a vibration sensor, an accelerometer, or an acoustic emission (AE) sensor, and detects a change in a physical quantity such as vibration or sound. The detector 30 is disposed, for example, in the vicinity of the tool, such as a drill, an end mill, a cutting tool tip, or a grindstone, which generates mechanical vibration. Alternatively, the detector 30 may be disposed, not on the tool side, but on a table on which the machining target is placed. The detector 30 can be fixed by a screw, a magnet, or an adhesive. Alternatively, a hole is made in the machine 70 (the processing machine) so that the detector 30 is embed in the hole. The detector 30 does not have to be fixed to the machine 70. The detector 30 may be disposed in the vicinity of the machine 70 to detect a change in a physical quantity such as vibration or sound generated by the machine 70. The number of detectors 30 is freely set. Further, any number of the plurality of detectors 30 may be of the same type to detect the same physical quantity, or of different types to detect different physical quantities.

The information processing apparatus 10 and the detector 30 together construct an information processing system 5. Between the information processing apparatus 10 and the detector 30, several types of filters to filter the output signal from the detector 30 or a filter selector to select the filter may be provided as necessary.

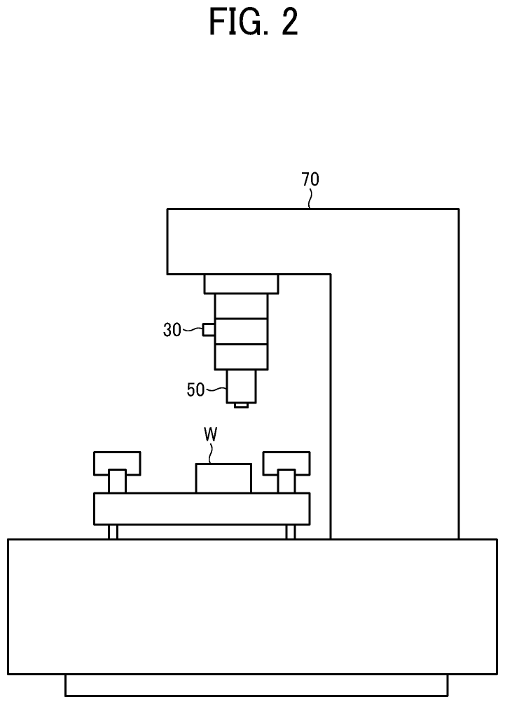

FIG. 2 is a view illustrating a machine according to the present embodiment. The machine 70 includes a tool 50 and a detector 30, and a workpiece W is disposed below the tool 50. The tool 50 is, for example, a drill, a reamer, a tap, an end mill, a face mill, or a cutting tool.

The detector 30 may be incorporated in advance in the machine 70, or may be attached to the machine 70 being a finished product. Further, the position of the detector 30 is not limited to the vicinity of the machine 70, but may be on the information processing apparatus 10 side.

Hardware Configuration

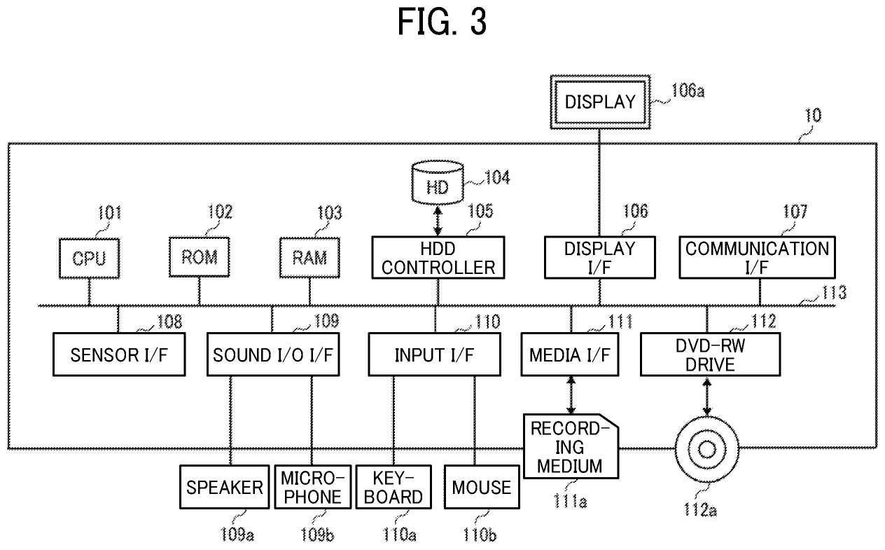

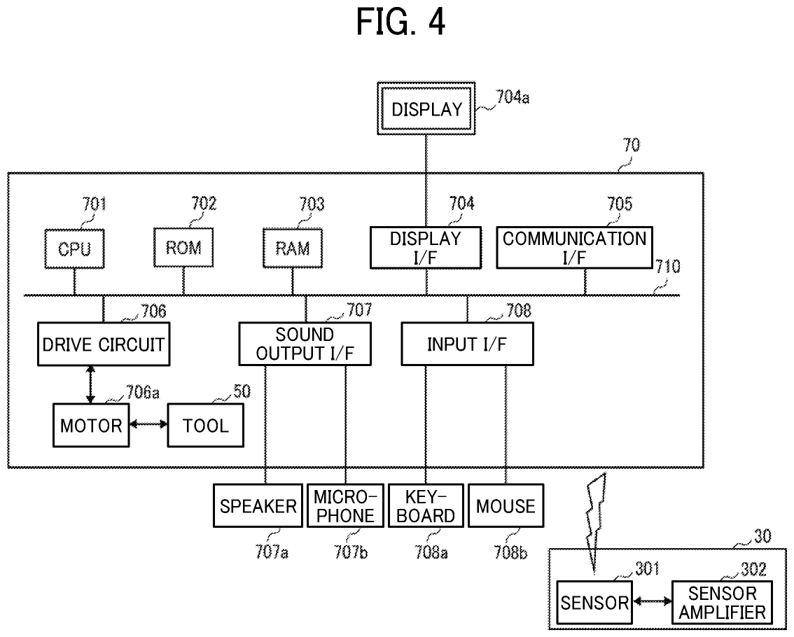

A description is given of hardware configurations of the information processing apparatus 10 and the machine 70 in the present embodiment with reference to FIGS. 3 and 4. The hardware configurations illustrated in FIG. 3 and FIG. 4 may be common among the embodiments of the present disclosure. Alternatively, some components or elements may be added thereto or deleted therefrom as required.

Hardware Configuration of Information Processing Apparatus

A hardware configuration of the information processing apparatus 10 according to the present embodiment is described with reference to FIG. 3. FIG. 3 is a block diagram illustrating an example of the hardware configuration of the information processing apparatus according to the present embodiment.

The information processing apparatus 10 is implemented by a computer, and, as illustrated in FIG. 3, includes a central processing unit (CPU) 101, a read only memory (ROM) 102, a random access memory (RAM) 103, a hard disk (HD) 104, a hard disk drive (HDD) controller 105, a display interface (I/F) 106, and a communication interface (I/F) 107.

The CPU 101 controls the entire operation of the information processing apparatus 10. The ROM 102 stores a program for controlling the CPU 101 such as an initial program loader (IPL) to boot the CPU 101. The RAM 103 is used as a work area for the CPU 101. The HD 104 stores various data such as a control program. The HDD controller 105 controls reading or writing of various data from or to the HD 104 under the control of the CPU 101. The display I/F 106 is a circuit to control a display 106a to display an image. The display 106a is, for example, a liquid crystal display or an organic electro luminescence (EL) display that displays an image of a subject, various icons, and the like. The communication I/F 107 is an interface circuit used for communication with an external device such as the machine 70. The communication I/F 107 is, for example, a network interface card (NIC) in compliance with transmission control protocol/internet protocol (TCP/IP).

The information processing apparatus 10 further includes a sensor I/F 108, a sound input/output I/F 109, an input I/F 110, a media I/F 111, and a digital versatile disk-ReWritable (DVD-RW) drive 112.

The sensor I/F 108 is an interface that receives a detection signal via a sensor amplifier 302 (see FIG. 4) included in the detector 30. The sound input/output I/F 109 is a circuit for controlling input and output of sound signals between a speaker 109a and a microphone 109b under control of the CPU 101. The input I/F 110 is an interface for connecting an input device (input means) to the information processing apparatus 10. A keyboard 110a is one example of an input device including a plurality of keys for a user to input characters, numerals, or various instructions. A mouse 110b is one example of an input device (input means) for the user to select a specific instruction or execution, select a target for processing, or move a cursor being displayed. Alternatively, instead of the keyboard 110a and the mouse 110b, a touch panel or the like may be used as the input device. The media I/F 111 controls reading or writing (storing) of data from or to a recording medium 111a such as a flash memory. The DVD-RW drive 112 controls reading or writing of various data from or to a DVD-RW 112a as one example of a removable recording medium. The removable recording medium is not limited to the DVD-RW and may be a digital versatile disk-recordable (DVD-R) or the like. Further, the DVD-RW drive 112 may be a Blu-ray drive that controls reading or writing of various data from or to a Blu-ray disc.

Further, the information processing apparatus 10 includes a bus line 113. Examples of the bus line 113 include an address bus and a data bus. The bus line 113 electrically connects the elements, such as the CPU 101, with each another.

A recording medium, such as a hard disk (HD) and a compact disc read-only memory (CD-ROM), storing the programs described above can be distributed domestically or internationally as a program product.

Hardware Configuration of Machine

A hardware configuration of the machine 70 is described with reference to FIG. 4. FIG. 4 is a block diagram illustrating an example of the hardware configuration of the machine according to the present embodiment.

As illustrated in FIG. 4, the machine 70 includes a CPU 701, a ROM 702, a RAM 703, a display I/F 704, a communication I/F 705, a drive circuit 706, a sound output I/F 707, and an input I/F 708.

The CPU 701 controls entire operation of the machine 70. The ROM 702 stores a control program for controlling the CPU 701 such as an IPL. The RAM 703 is used as a work area for the CPU 701. The display I/F 704 is a circuit to control the display 704a to display an image. A display 704a is, for example, a liquid crystal display or an organic EL display that displays an image of a subject, various icons, and the like.

The communication I/F 705 is an interface for communication with an external device such as the information processing apparatus 10. The communication I/F 705 is, for example, an NIC in compliance with TCP/IP.

The drive circuit 706 is a circuit that controls the drive of a motor 706a. The motor 706a drives the tool 50 used for machining. Examples of the tool 50 include a drill, an end mill, a cutting tool tip, a grindstone, and a table that supports a machining target and moves corresponding to the machining.

The sound output I/F 707 is a circuit that processes the output of a sound signal between a speaker 707a and a microphone 707b under the control of the CPU 701. The input I/F 708 is an interface for connecting an input device (input means) to the machine 70. A keyboard 708a is one example of the input device including a plurality of keys for a user to input characters, numerals, or various instructions. A mouse 708b is one example of the input device for the user to select a specific instruction or execution, select a target for processing, or move a cursor being displayed. Alternatively, instead of the keyboard 708a and the mouse 708b, a touch panel or the like may be used as the input device.

The machine 70 further includes a bus line 710. Examples of the bus line 710 include an address bus and a data bus. The bus line 710 electrically connects the elements, such as the CPU 701, with each another.

The detector 30, which detects the physical quantity (e.g., vibration or sound) output from the machine 70, includes a sensor 301 and the sensor amplifier 302. As described above, the sensor 301 detects the physical quantity such as vibration, sound, or the like generated by the contact between the tool 50 of the machine 70 and the machining target during the processing; or vibration, sound, or the like generated by the tool 50 or the machine 70 itself. The sensor 301 acquires a detection signal (sensor data) based on the detected physical quantity information. The sensor 301 is, for example, a microphone, a vibration sensor, an accelerometer, or an AE sensor. The sensor amplifier 302 adjusts the detection sensitivity of the sensor 301 and outputs the detection signal based on the detection by the sensor 301.

Functional Configuration

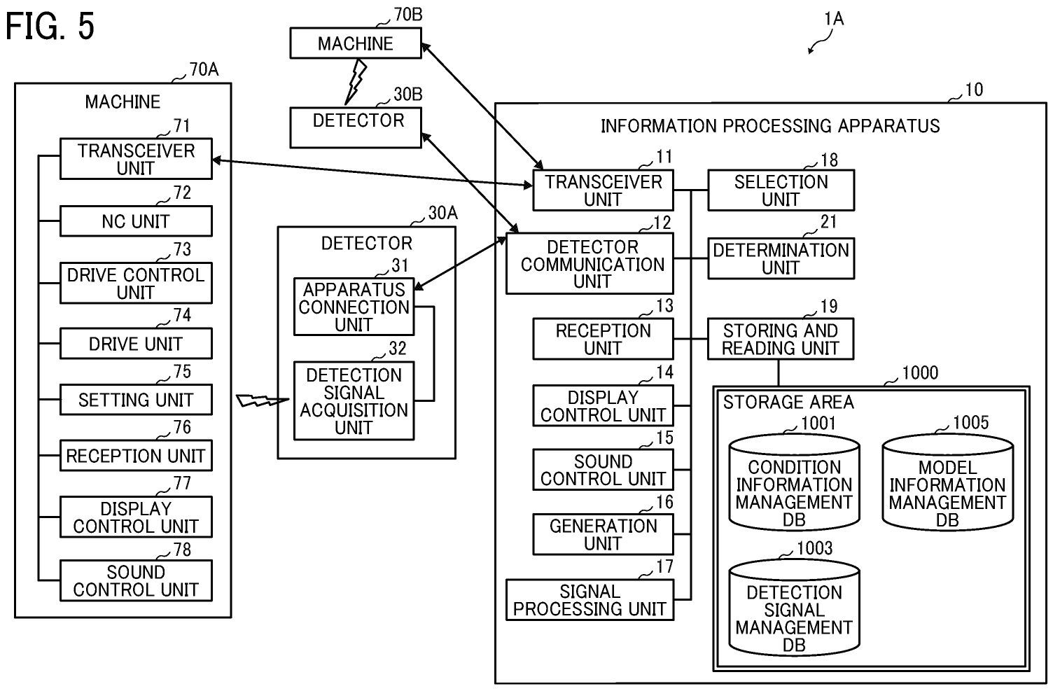

A description is given of functional configurations of the apparatuses and devices according to the present embodiment. FIG. 5 is a block diagram illustrating an example of a functional configuration of the abnormality detection system according to the present embodiment.

Functional Configuration of Information Processing Apparatus

A description is given of the functional configuration of the information processing apparatus 10. The functions implemented by the information processing apparatus 10 include a transmission and reception unit 11, a detector communication unit 12, a reception unit 13, a display control unit 14, a sound control unit 15, a generation unit 16, a signal processing unit 17, a selection unit 18, a determination unit 21, a storing and reading unit 19, and a storage area 1000.

The transmission and reception unit 11 has a function of transmitting and receiving various data (or information) to and from an external device such as the machine 70. The transmission and reception unit 11 receives, for example, processing information (machining information) relating to the current operation of the first machine 70A and the second machine 70B. The transmission and reception unit 11 is mainly implemented by the communication I/F 107 illustrated in FIG. 3 and a program executed by the CPU 101.

The processing information received by the transmission and reception unit 11 includes sequence information, cycle information, tool information, and machine identifiers (IDs). The sequence information (an example of process identification information) is for identifying a particular one of a plurality of processes performed by the first machine 70A and the second machine 70B on the same workpiece. The cycle information (an example of workpiece identification information) is for identifying a particular one of a plurality of workpieces to be subjected to the same process in the first machine 70A or the second machine 70B. The tool information (an example of tool identification information) is for identifying the tool type used for each of the plurality of processes. The machine IDs (an example of processing machine identification information) is for identifying each of the first machine 70A and the second machine 70B. The transmission and reception unit 11 is an example of an identification information acquisition unit that acquires identification information.

The detector communication unit 12 has a function of performing data communication between the first detector 30A and the second detector 30B. The detector communication unit 12 receives, for example, a first detection signal (sensor data) relating to the physical quantity detected by the first detector 30A, and a second detection signal on the physical quantity detected by the second detector 30B. The detector communication unit 12 is mainly implemented by a program executed by the CPU 101 illustrated in FIG. 3. The detector communication unit 12 is an example of a detection result acquisition unit that acquires detection result (detection information). The detection signal received by the detector communication unit 12 is an example of detection result relating to the physical quantity that changes as machining (an example of processing) is performed on the workpiece.

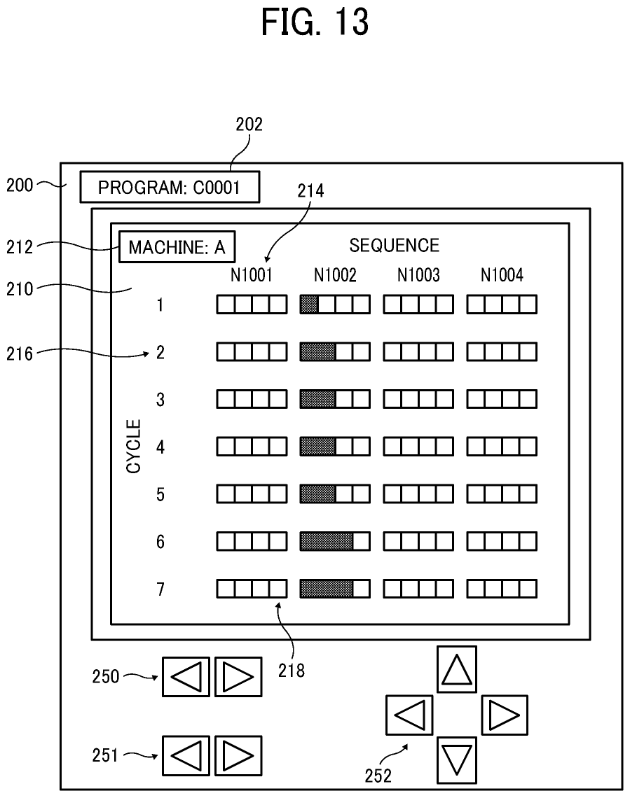

The reception unit 13 has a function of receiving user input via the input device such as the keyboard 110a illustrated in FIG. 3. The reception unit 13 receives, for example, selection of output items in response to an input to an information display screen 200 (see FIG. 13). The reception unit 13 is mainly implemented by a program executed by the CPU 101 illustrated in FIG. 3.

The display control unit 14 has a function of displaying various screens on the display 106a illustrated in FIG. 3. The display control unit 14 controls, for example, display of the information display screen 200 (see FIG. 13) on the display 106a. Specifically, for example, the display control unit 14 launches and executes a software application that operates on an operating system (OS), thereby downloading a web application (web app), which includes at least hypertext markup language (HTML), and further includes cascading style sheets (CSS) or JAVASCRIPT (registered trademark). Then, the display control unit 14 displays, on the display 106a, various image data generated by the web app. The display control unit 14 displays, on the display 106a, for example, image data generated by HTML5 including data in the format of Extensible Markup Language (XML), JavaScript Object Notation (JSON), or Simple Object Access Protocol (SOAP). The display control unit 14 is mainly implemented by the display I/F 106 illustrated in FIG. 3, a program executed by the CPU 101, and the like.

The sound control unit 15 has a function of outputting a sound signal from the speaker 109a illustrated in FIG. 3. The sound control unit 15 sets a detection signal to be output from the speaker 109a, and outputs, as sound, the set detection signal from the speaker 109a. The sound control unit 15 is mainly implemented by the sound input/output I/F 109 illustrated in FIG. 3, a program executed by the CPU 101, and the like.

The generation unit 16 has a function of generating various image data to be displayed on the display 106a. The generation unit 16 generates, for example, image data relating to the information display screen 200 (see FIG. 13) to be displayed on the display 106a. The generation unit 16 performs rendering of, for example, the data stored in the storage area 1000 and generates image data for displaying based on the rendered data. Rendering is a process of interpreting data described in a language (e.g., HTML, CSS, or XML) for describing Web pages and calculating the arrangement of characters, image data, etc. actually displayed on the screen. The generation unit 16 generates a condition ID for identifying condition information including the received processing information in response to a reception by the transmission and reception unit 11 of the processing information. The generation unit 16 is mainly implemented by a program executed by the CPU 101 illustrated in FIG. 3.

The signal processing unit 17 has a function of processing the detection signal received by the detector communication unit 12. A detailed description of the signal processing unit 17 is deferred. The signal processing unit 17 is mainly implemented by a program executed by the CPU 101 illustrated in FIG. 3. Alternatively, the signal processing unit 17 can be implemented by a circuit.

The selection unit 18 has a function of selecting a detection signal to be acoustically output based on a signal output request from the user. The selection unit 18 selects, for example, a detection signal stored in association with condition information corresponding to the output item data included in the signal output request, received by reception unit 13. The selection unit 18 is mainly implemented by a program executed by the CPU 101 illustrated in FIG. 3.

The determination unit 21 has a function of performing various kinds of determination, and is implemented mainly by operations of the CPU 101 illustrated in FIG. 3. The determination unit 21 calculates, for example, the difference in signal data relating to a plurality of detection signals selected by the selection unit 18.

The storing and reading unit 19 has a function of storing various data in the storage area 1000 and reading various data from the storage area 1000. The storing and reading unit 19 is implemented by, for example, a program executed by the CPU 101 illustrated in FIG. 3. The storage area 1000 is implemented mainly by the ROM 102, the HD 104, and the recording medium 111a illustrated in FIG. 3.

The storage area 1000 includes a condition information management database (DB) 1001, a detection signal management DB 1003, and a model information management DB 1005. The condition information management DB 1001 is constructed of a condition information management table described later. The detection signal management DB 1003 is constructed of a detection signal management table described later. The model information management DB 1005 is constructed of a model information management table described later. The storing and reading unit 19 is an example of a storing control unit.

Functional Configuration of Detector

A description is given of a functional configuration of the detector 30. The functions implemented by the detector 30 include an apparatus connection unit 31 and a detection signal acquisition unit 32.

The apparatus connection unit 31 has a function of transmitting the detection signal acquired by the detection signal acquisition unit 32 to the information processing apparatus 10. The apparatus connection unit 31 is mainly implemented by the sensor amplifier 302 illustrated in FIG. 4.

The detection signal acquisition unit 32 has a function of detecting the physical quantity (such as vibration or sound) that changes depending on the operation of the machine 70, and acquiring the information on the physical quantity as a detection signal. The detection signal acquisition unit 32 is mainly implemented by the sensor 301 illustrated in FIG. 4. The detection signal acquisition unit 32 detects the physical quantity that is vibration, sound, or the like generated when the tool 50 (such as a drill, end mill, cutting tool tip, or grindstone) installed in the machine 70 contacts the machining target during the processing; or vibration, sound, or the like generated by the tool 50 or the machine 70 itself. The detection signal acquisition unit 32 acquires the detected physical quantity information as a detection result (sensor data). For example, when a blade of the tool 50 used for machining is broken, chipping of the blade, or the like occurs, and the sound during machining changes. Therefore, the detection signal acquisition unit 32 detects acoustic data using the sensor 301 such as a microphone, and transmits the detection signal relating to the detected acoustic data to the information processing apparatus 10 via the apparatus connection unit 31. The detection signal acquisition unit 32 is mainly implemented by the sensor 301 illustrated in FIG. 4.

Functional Configuration of Machine

The functions implemented by the machine 70 include a transmission and reception unit 71, a numerical control (NC) unit 72, a drive control unit 73, a drive unit 74, a setting unit 75, a reception unit 76, a display control unit 77, and a sound control unit 78.

The transmission and reception unit 71 has a function of transmitting and receiving various data (or information) to and from an external device such as the information processing apparatus 10. The transmission and reception unit 71 transmits the processing information relating to the current operation of the machine 70 to the information processing apparatus 10. The transmission and reception unit 71 is mainly implemented by the communication I/F 705 illustrated in FIG. 4 and a program executed by the CPU 701.

The numerical control unit 72 has a function of executing machining by the drive control unit 73 with numerical control (NC). For example, the numerical control unit 72 generates and outputs numerical control data for controlling the operation of the drive unit 74. Further, the numerical control unit 72 outputs processing information relating to the operation of the machine 70 to the transmission and reception unit 71. For example, the numerical control unit 72 sequentially transmits context information corresponding to the current operation of the machine 70 to the information processing apparatus 10 via the transmission and reception unit 71. In machining on the machining target, the numerical control unit 72 changes the type of the drive unit 74 to be driven or the drive state (rotation number, rotation speed, etc.) of the drive unit 74 in accordance with the machining process. Each time the type of operation is changed, the numerical control unit 72 sequentially transmits the context information corresponding to the changed type of operation to the information processing apparatus 10 via the transmission and reception unit 71. The numerical control unit 72 is mainly implemented by a program or the like executed by the CPU 701 illustrated in FIG. 4.

The drive control unit 73 has a function of controlling the drive unit 74 based on numerical control data obtained by the numerical control unit 72. The drive control unit 73 is implemented by, for example, the drive circuit 706 illustrated in FIG. 4. The drive control unit 73 is mainly implemented by the drive circuit 706 illustrated in FIG. 4 and a program executed by the CPU 701.

The drive unit 74 has a function that is a target of drive control by the drive control unit 73. The drive unit 74 drives the tool 50 under the control of the drive control unit 73. The drive unit 74 is an actuator that is controlled by the drive control unit 73, and is mainly implemented by the motor 706a illustrated in FIG. 4. The drive unit 74 may be any actuator used for machining and is subject to numerical control. Further, two or more drive units 74 may be provided.

The setting unit 75 has a function of setting condition information corresponding to the current operation of the machine 70. The setting unit 75 is mainly implemented by a program executed by the CPU 701 illustrated in FIG. 4.

The reception unit 76 has a function of receiving user input via the input device such as the keyboard 708a illustrated in FIG. 4. The reception unit 76 receives, for example, selection of output items in response to an input to an information display screen 200 (see FIG. 13) on the display 704a. The reception unit 76 is mainly implemented by the input I/F 708 illustrated in FIG. 4 and a program executed by the CPU 701.

The display control unit 77 has a function of displaying various screen information on the display 704a illustrated in FIG. 4. The display control unit 77 displays, for example, the information display screen 200 (see FIG. 13) on the display 704a. The display control unit 77 is mainly implemented by the display I/F 704 illustrated in FIG. 4 and a program executed by the CPU 701.

The sound control unit 78, which is implemented by instructions from the CPU 701 illustrated in FIG. 4, controls the speaker 707a to output a sound signal. The sound control unit 78 sets a detection signal to be output from the speaker 707a, and outputs, as sound, the set detection signal from the speaker 707a. The sound control unit 78 is mainly implemented by the sound output I/F 707 illustrated in FIG. 4 and a program executed by the CPU 701.

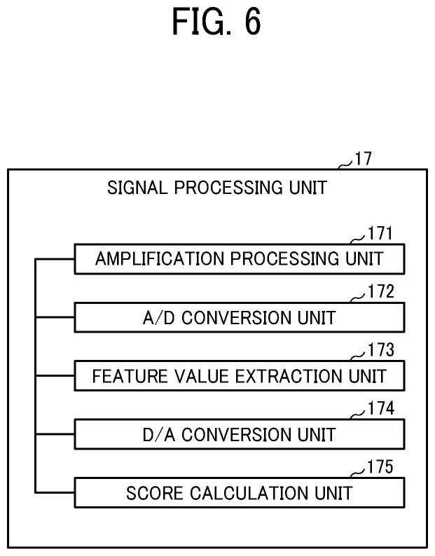

With reference to FIG. 6, a description is given in detail of the functional configuration of the signal processing unit 17 of the information processing apparatus 10 illustrated in FIG. 5. FIG. 6 is a block diagram illustrating an example of the functional configuration of the signal processing unit according to the present embodiment. The signal processing unit 17 illustrated in FIG. 6 includes an amplification processing unit 171, an analog-to-digital (A/D) conversion unit 172, a feature value extraction unit 173, a digital-to-analog (D/A) conversion unit 174, and a score calculation unit 175.

The amplification processing unit 171 has a function of amplifying the detection signal received by the detector communication unit 12. The amplification processing unit 171 amplifies, for example, an analog signal received by the detector communication unit 12 to a given size. Further, the amplification processing unit 171 amplifies, for example, a digital signal converted by the A/D conversion unit 172 to a given size.

The A/D conversion unit 172 has a function of converting an analog signal amplified by the amplification processing unit 171 into a digital signal.

The feature value extraction unit 173 has a function of extracting a feature value (feature information) indicating a feature of the detection signal received by the detector communication unit 12. The feature value may be any information that indicates a feature of the detection signal. For example, when the detection signal is acoustic data, the feature value extraction unit 173 may extract energy, frequency spectrum, time, mel frequency cepstrum coefficient (MFCC), or the like as the feature value.

The D/A conversion unit 174 has a function of converting a digital signal amplified by the amplification processing unit 171 into an analog signal.

The score calculation unit 175 calculates a score as an example of abnormality likelihood information indicating the likelihood of abnormality of the machine 70 from the feature value (for example, frequency spectrum) of the detection signal extracted by the feature value extraction unit 173. The score calculation unit 175 is an example of an abnormality likelihood information determination unit and determines the likelihood of abnormality of the machine 70, the cycle, or sequence and generates abnormality likelihood information indicating the likelihood of abnormality.

A description is given below of processing or operation according to the present embodiment.

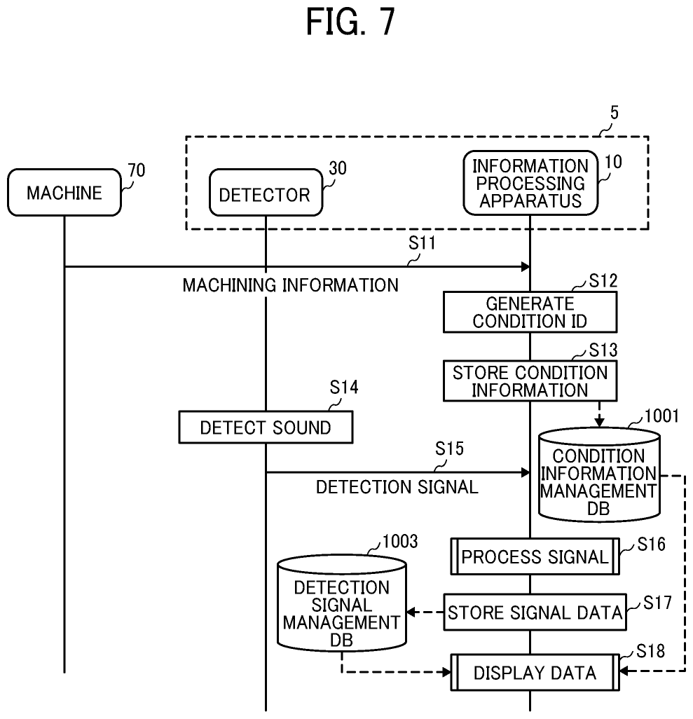

Storing of Detection Signal FIG. 7 is a sequence chart illustrating an example of storing of the detection signal and displaying of information in the abnormality detection system according to the present embodiment. The abnormality detection system 1A executes the processes illustrated in FIG. 7 for each of the first machine 70A and the second machine 70B. The processes in FIG. 7 are on the premise that the first machine 70A and the second machine 70B simultaneously perform the same process.

In step S11, the transmission and reception unit 71 of the machine 70 transmits the processing information relating to the current operation of the machine 70 to the information processing apparatus 10 of the information processing system 5. Specifically, the setting unit 75 of the machine 70 sets processing information including specific processing contents at the start of processing on the work (machining target). As described above, the processing information is context information defined for each type of operation of the machine 70. Then, the transmission and reception unit 71 transmits the processing information set by the setting unit 75 to the information processing apparatus 10. As a result, the transmission and reception unit 11 of the information processing apparatus 10 receives a plurality of first processing information transmitted from the first machine 70A and second processing information transmitted from the second machine 70B (an example of acquiring processing information and acquiring identification information). The processing information can be acquired in real time.

In step S12, the generation unit 16 of the information processing apparatus 10 generates condition ID for identifying the condition information including the processing information received by the transmission and reception unit 11.

In step S13, the storing and reading unit 19 stores, in the condition information management DB 1001, the condition ID generated by the generation unit 16, condition information associated with the plurality of first processing information and the plurality of second processing information received by the transmission and reception unit 11 (an example of controlling of storing). The condition information management DB 1001 stores, in the condition information management table, each condition ID in association with the processing information indicating the contents of the specific processing executed by the machine 70.

In step S14, the detection signal acquisition unit 32 of the detector 30 of the information processing system 5 detects the physical quantity such as vibration or sound generated by the machine 70. The detection signal acquisition unit 32 detects the sound generated by the machine 70 and acquires the detection signal (acoustic signal) relating to the detected sound.

In step S15, the apparatus connection unit 31 of the detector 30 transmits the detection signal acquired in step S14 to the information processing apparatus 10. As a result, the detector communication unit 12 of the information processing apparatus 10 receives the first detection signal transmitted from the first detector 30A and the second detection signal transmitted from the second detector 30B (an example of acquiring the detection result).

In step S16, the signal processing unit 17 of the information processing apparatus 10 processes the detection signal received by the detector communication unit 12.

In step S17, the storing and reading unit 19 of the information processing apparatus 10 stores the signal data processed by the signal processing unit 17 in the detection signal management DB 1003 (an example of controlling storing). The information processing apparatus 10 stores, in the detection signal management table, each condition ID generated in step S12 in association with the signal data relating to the detection signal received in step S15 and the signal data (frequency data or score data) processed by the signal processing unit 17.

In step S18, the storing and reading unit 19 of the information processing apparatus 10 reads the processing information associated with the condition ID from the condition information management DB 1001, and reads the signal data associated with the condition ID from the detection signal management DB 1003. The display control unit 14 of the information processing apparatus 10 displays the processing information read from the condition information management DB 1001 in association, via the condition ID, with the signal data read from the detection signal management DB 1003 on the information display screen 200 on the display 106a.

Condition Information Management Table

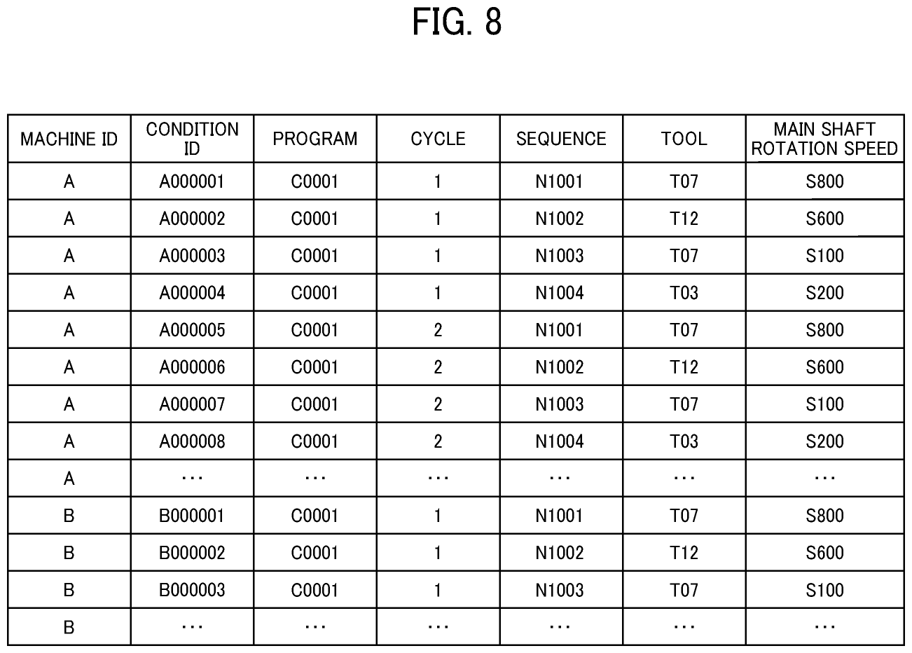

FIG. 8 is a conceptual diagram illustrating an example of the condition information management table according to the present embodiment. As described in step S13 of FIG. 7, the storage area 1000 includes the condition information management DB 1001 constructed of the condition information management table as illustrated in FIG. 8. The processes illustrated in FIG. 7 are executed for each of the first machine 70A and the second machine 70B. Accordingly, the condition information management table illustrated in FIG. 8 stores the first condition information of the first machine 70A and the second condition information of the second machine 70B.

The condition information management table illustrated in FIG. 8 is for managing processing information relating to the operation of the machine 70 for each operation performed by the machine 70. In the condition information management table, the condition information associated with processing information for each condition ID is stored. The machine ID is identification information for identifying the machine 70 (an example of processing machine identification information), “A” represents the machine 70A and “B” represents the machine 70B. The condition ID is identification information for identifying the condition information including the processing information. The processing information is context information defined for each type of operation of the machine 70.

As illustrated in FIG. 8, the processing information includes machining program information for performing a predetermined sequence in a predetermined cycle, cycle information (an example of workpiece identification information) for identifying each of a plurality of workpieces to be subjected to the same machining, sequence information for identifying each of a plurality of processes performed on the same workpiece (example of process identification information), type information of the tool 50 (an example of tool identification information), and rotation speed of a spindle or a main shaft (an example of tool control condition identification information).

Examples of the type of the tool 50 include a drill, an end mill, a face mill, a ball end mill, a stop facing cutter, a boring tool, a cutting tool tip, and a grindstone, each assigned with tool identification information.

The sequence information may include a processing method (processing type) by the machine 70. The processing method includes cutting and polishing, and more specifically, drilling, through-hole drilling, peck drilling, grooving, side face processing, contour processing, ramping processing, and deburring.

The processing information may include information on the cumulative number of jobs from the start of that operation and information on the material of the work processed by the machine 70. Examples of the material of the work include alloys, carbon resins, and resin materials. More specifically, the material of the work is represented, for example, by a grade such as S50C, FC250, and S20CK specified by Japanese Industrial Standards (JIS).

Items included in the processing information may further include history information on operation by the user on the machine 70, the number of processing times in one job (an example of the number of operations of the machine 70), identification information of the machine 70, configuration information such as the diameter of the tool 50 and the material of the tool 50, and information indicating the operating state of the tool 50. The information indicating the operating state of the tool 50 includes, for example, an on/off signal (“ladder signal”) to specify a section from feeding of the work (machining target) to the end of the machining by the tool 50. The items included in the processing information may further include the cumulative usage time of the tool 50 (the drive unit 74) from the start of use, the load relating to the tool 50 (the drive unit 74), the rotation speed of the tool 50 (the drive unit 74), and information indicating machining conditions such as the machining speed of the tool 50 (the drive unit 74). Further, the processing information may include the machining time (an example of the operating time of the machine 70) and include the machining time instead of the number of machining times.

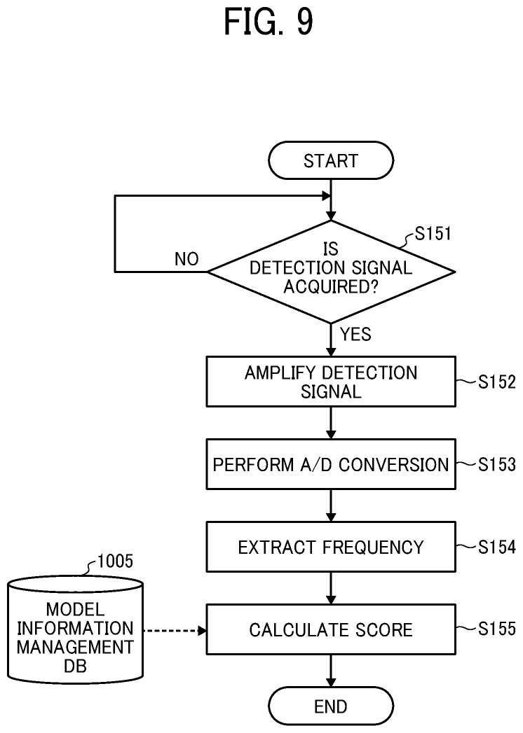

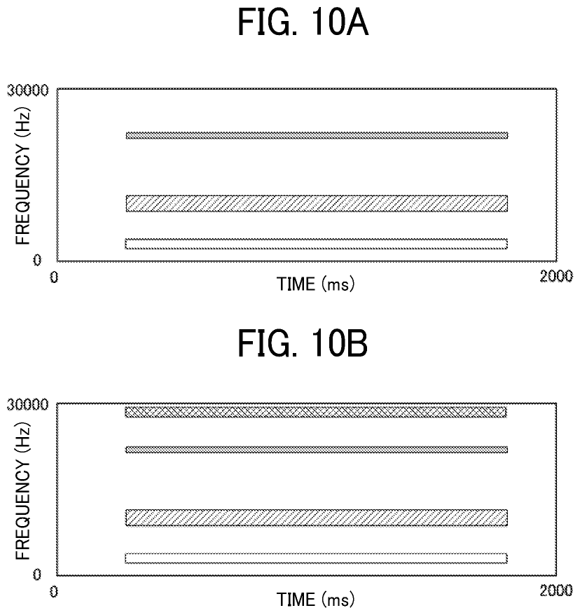

Next, a description is given of processing of the detection signal by the signal processing unit 17 corresponding to step S16 in FIG. 7, with reference to FIGS. 9 to 10B.

FIG. 9 is a flowchart illustrating an example of processing of the detection signal performed by the information processing apparatus according to the present embodiment. Since the processing illustrated in FIG. 7 is executed for each of the first machine 70A and the second machine 70B, the processing illustrated in FIG. 9 is also executed for each of the first machine 70A and the second machine 70B.

In step S151, in response to a reception (acquisition) of the detection signal by the detector communication unit 12, the information processing apparatus 10 proceeds to step S152. The information processing apparatus 10 repeats the process of step S151 until the detector communication unit 12 receives (acquires) the detection signal.

In step S152, the amplification processing unit 171 of the signal processing unit 17 amplifies the detection signal received (acquired) by the detector communication unit 12 to a given size. In step S153, the A/D conversion unit 172 of the signal processing unit 17 converts the analog signal amplified by the amplification processing unit 171 into a digital signal.

In step S154, the feature value extraction unit 173 of the signal processing unit 17 extracts the feature value (feature information) indicating the feature of the digital signal converted by the A/D conversion unit 172 (an example of extracting a feature value). In the present embodiment, the feature value extraction unit 173 extracts a frequency spectrum included in the digital signal converted by the A/D conversion unit 172.

In step S155, the score calculation unit 175 of the signal processing unit 17 calculates a score indicating the likelihood of abnormality of the machine 70 from the feature value (for example, frequency spectrum) of the detection signal extracted by the feature value extraction unit 173.

Specifically, the score calculation unit 175 calculates a likelihood that the feature information of the detection result is normal, using model information of the feature information. The model information indicates normal data stored in the model information management DB 1005 of the storage area 1000. Then, the score calculation unit 175 calculates the reciprocal of the likelihood as the score.

The score calculation unit 175 may calculate the score by ranking the scores stepwise, or may calculate the score with binary values of 0 and 1. In addition, the score calculation unit 175 may accumulate the calculated scores.

Alternatively, the score calculation unit 175 may calculate, as the score, a likelihood that the feature information of the detection result has an abnormality, using model information of the feature information that indicates abnormal data stored in the model information management DB 1005.

Since the processing illustrated in FIG. 9 is executed for each of the first machine 70A and the second machine 70B, the first feature value is extracted from the first detection signal, based on which the first score is calculated; and the second feature value is extracted from the second detection signal, based on which the second score is calculated.

A description is given of the frequency component of the detection signal detected during the operation of the machine 70, which corresponds to step S154 of FIG. 9.

FIG. 10A illustrates a spectrogram of a detection signal detected when the machining operation of the machine 70 is normal. FIG. 10B illustrates a spectrogram of a detection signal detected when the machining operation of the machine 70 has an abnormality. As illustrated in FIG. 10B, when an abnormality occurs during the machining operation of the machine 70, a frequency component around 30,000 Hz appears.

Then, in the score calculation in step S155 of FIG. 9, for example, in the case where the spectrogram illustrated in FIG. 10B is model information indicating abnormal data, the score calculation unit 175 calculates the likelihood of abnormality of the spectrogram of the detection signal as the score. The score calculation unit 175 calculates the likelihood based on the amount of the frequency components around 30,000 Hz in the spectrogram of the detection signal extracted by the feature value extraction unit 173.

Detection Signal Management Table

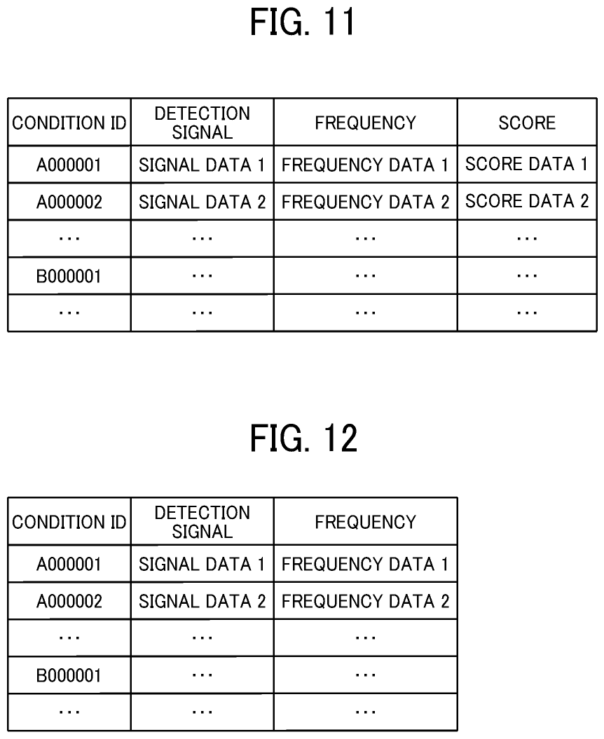

FIG. 11 is a conceptual diagram illustrating an example of the detection signal management table according to the present embodiment. As described in step S17 of FIG. 7, the storage area 1000 includes the detection signal management DB 1003 constructed with the detection signal management table as illustrated in FIG. 11.

Since the processing illustrated in FIG. 7 is executed for each of the first machine 70A and the second machine 70B, the detection signal management table illustrated in FIG. 11 stores the first data and the second data of the first machine 70A and the second machine 70B, respectively.

The detection signal management table illustrated in FIG. 11 is for managing the detection signal transmitted from the detector 30 in association with the processing information transmitted from the machine 70. In the detection signal management table, the detection signal, the frequency data extracted by the feature value extraction unit 173, and the score data calculated by the score calculation unit 175 are stored in association for each condition ID. The condition ID is identification information for identifying the condition information included in the condition information management table illustrated in FIG. 8. As a result, the signal data (detection signal) is stored in association with the related data (processed signal data such as frequency data and score data) for each condition ID.

Further, the detection signal management table stores a plurality of first processing information (condition ID: A000001, . . . ) indicating a plurality of first processing performed by the first machine 70A, and a plurality of second processing information (condition ID: B000001, . . . ) indicating a plurality of second processing performed by the second machine 70B.

That is, the detection signal management table stores each of the plurality of first feature values in association with each of the plurality of first processing information, and also stores each of the plurality of second feature values in association with each of the plurality of second processing information.

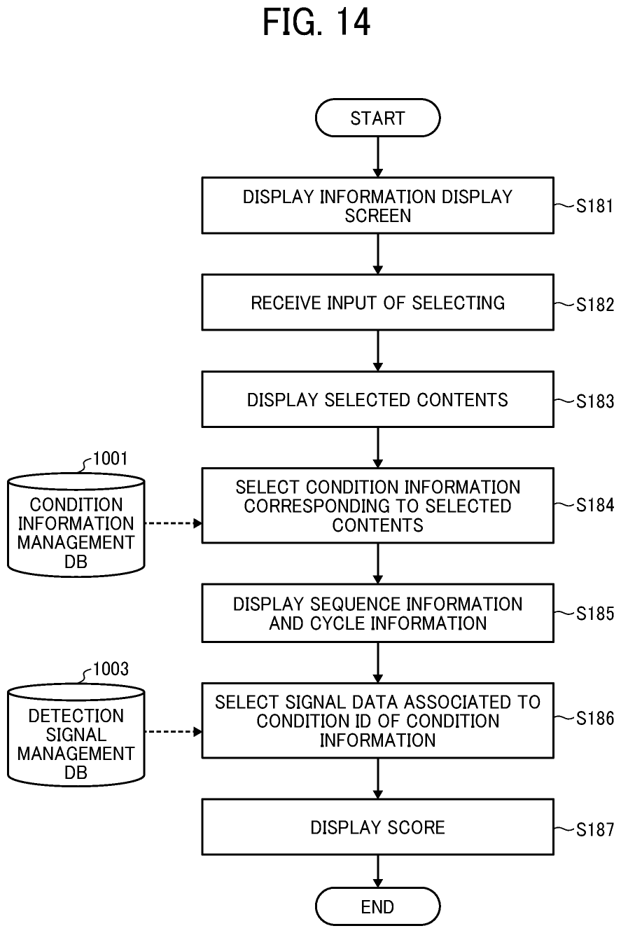

FIG. 12 is a conceptual diagram illustrating an example of the model information management table according to the present embodiment, which corresponds to step S155 in FIG. 9. The storage area 1000 includes the model information management DB 1005 constructed of the model information management table illustrated in FIG. 14. Since the processing illustrated in FIG. 9 is executed for each of the first machine 70A and the second machine 70B, the model information management table illustrated in FIG. 12 stores the first model information and the second model information of the first machine 70A and the second machine 70B, respectively.

In the model information management table, the storing and reading unit 19 stores a plurality of entries in each of which the condition ID, the detection signal, and the frequency data are associated with each other.

Alternatively, the model information management table may store only frequency data without storing the detection signal. Yet alternatively, the model information management table may store only the detection signal without storing the frequency data, and the signal processing unit 17 may again perform the processes in S152 to S154 of FIG. 9 based on the detection signal stored in the model information management table, to extract the frequency data.

FIG. 13 illustrates a first example of the information display screen displayed on the information processing apparatus according to the present embodiment. FIG. 14 is a flowchart illustrating an example of displaying performed by the information processing apparatus according to the present embodiment.

As described in step S18 of FIG. 7, the display control unit 14 of the information processing apparatus 10 displays the processing information read from the condition information management DB 1001 and the signal data read from the detection signal management DB 1003 in association with each other via the condition ID on the information display screen 200 on the display 106a.

As illustrated in FIG. 13, the information display screen 200 includes a program display area 202, an information display area 210, program selection buttons 250, machine selection buttons 251, and information display area selection buttons 252. The information display area 210 includes a machine ID display area 212, a sequence display area 214, a cycle display area 216, and a score display area 218.

In step S181 illustrated in FIG. 14, the display control unit 14 of the information processing apparatus 10 displays the information display screen 200 on the display 106a. Specifically, the display control unit 14 displays the information display screen 200 in response to a reception, by the reception unit 13, of an input to a predetermined input screen displayed on the display 106a.

In step S182, the reception unit 13 of the information processing apparatus 10 receives a selection request of the program selected (input) with the program selection buttons 250, the device selected (input) with the machine selection buttons 251, and the display area selected (input) with the information display area selection buttons 252.

In step S183, the display control unit 14 displays selected contents, that is, information indicating the program whose selection has been accepted by the reception unit 13 in step S182 in the program display area 202, and information indicating the machine ID whose selection has been accepted by the reception unit 13 in the machine ID display area 212.

In step S184, the selection unit 18 of the information processing apparatus 10 selects, from the processing information stored in the condition information management DB 1001 (see FIG. 8), the processing information associated with the program and machine ID whose selection has been accepted by the reception unit 13 in step S182.

Specifically, the storing and reading unit 19 reads the condition information management table from the condition information management DB 1001. Then, the selection unit 18 selects, from the condition information included in the read condition information management table, the condition information that includes the processing information associated with the program and the machine ID whose selection is accepted by the reception unit 13 in step S182. In this case, the selection unit 18 selects, for example, the condition information of the condition ID including the processing information corresponding to the input program “C0001” and the machine ID “A”.

In step S185, from the processing information selected by the selection unit 18 in step S184, the display control unit 14 displays a plurality of sequence information in the sequence display area 214, and displays a plurality of cycle information in the cycle display area 216.

In a case where all of the plurality of sequence information or all of the plurality of cycle information cannot be displayed on the information display screen 200, the display control unit 14 changes the plurality of sequence information or the plurality of cycle information to be displayed on the information display screen 200, in accordance with the display area whose selection is accepted by the reception unit 13 in step S182.

In step S186, the selection unit 18 selects, from the data stored in the detection signal management DB 1003 (see FIG. 11), the signal data and related data associated with the same condition ID as the condition ID associated with the processing information selected by the selection unit 18 in step S184. Specifically, the storing and reading unit 19 reads the detection signal management table from the detection signal management DB 1003. Then, the selection unit 18 selects, from the data included in the read detection signal management table, the signal data and the related data associated with the condition ID included in the condition information selected by the selection unit 18 in step S184.

In step S187, the display control unit 14 displays, in the score display area 218, the score data included in the signal data and related data, selected by the selection unit 18 in step S186, in association with each of the plurality of sequence information and each of the plurality of cycle information (an example of displaying).

In the first example illustrated in FIG. 13, the score displayed in the score display area 218 is represented by four display blocks. The display control unit 14 controls the whether to display (whether to turn black from white) each of the four display blocks. The display control unit 14 compares the score data with the reference value and controls the display of the four display blocks based on the comparison result.

Specifically, the score data represents a value of 0 to 100%. The display control unit 14 compares the score data with a first reference value of 25%, a second reference value of 50%, a third reference value of 75%, and a fourth reference value of 100%. The display control unit 14 does not display (turn black) none of the four display blocks when the score data is less than 25%. The display control unit 14 displays (turns black) only the first display block from the left of the four display blocks when the score data is 25% or greater and less than 50%. The display control unit 14 displays (turns black) the first and second display blocks from the left of the four display blocks when the score data is 50% or greater and less than 75%. The display control unit 14 displays (turns black) the first, second, and third display blocks from the left of the four display blocks when the score data is 75% or greater and less than 100%, and displays (turns black) all the four display blocks when the score data is 100%. As illustrated in FIG. 13, among the plurality of sequences N1001 to N1004, the sequences N1001, N1003, and N1004 do not contain a high score (25% or greater in this example), but the sequence N1002 contains a high score. Therefore, estimation can be made that the sequence N1002 has an abnormality.

Further, the scores are high in all of the plurality of cycles 1 to 7 in the sequence N1002.

Therefore, estimation can be made that the sequence N1002 has an abnormality independent of a specific cycle.

In FIG. 13, the score data (likelihood information) is associated with the sequence information (processing identification information) and the cycle information (workpiece identification information). Alternatively, the score data may be displayed in association with only one of the sequence information and the cycle information. For example, when only the sequence N1002 includes high scores as in FIG. 13, only the column of the sequence N1002 may be displayed.

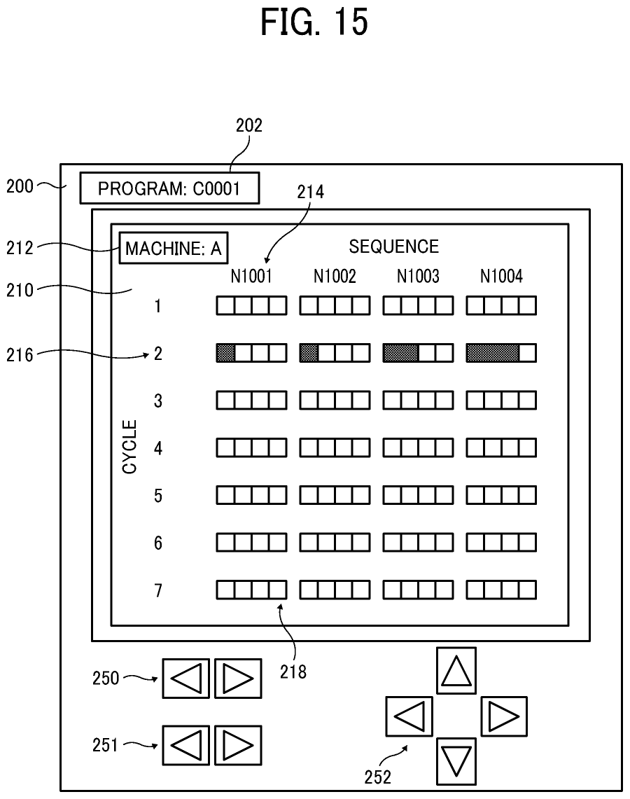

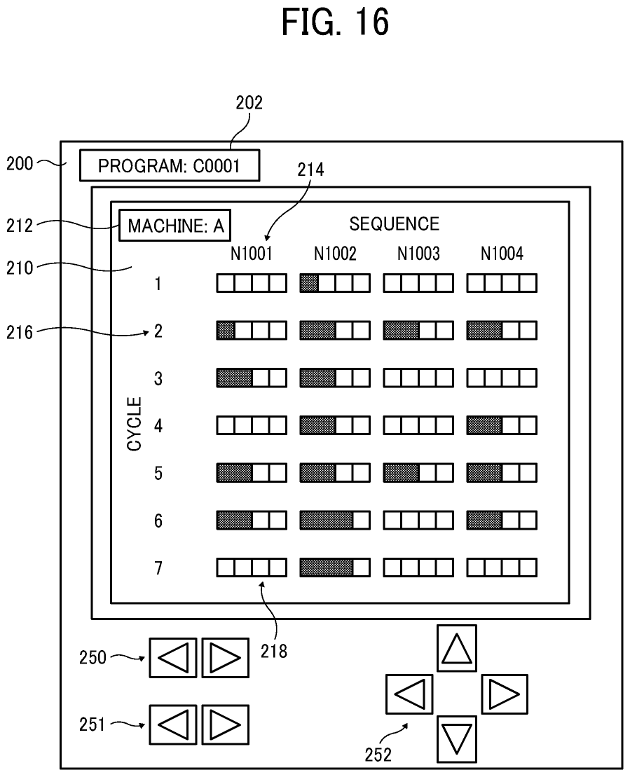

FIGS. 15 and 16 illustrate second and third examples of the information display screen displayed on the information processing apparatus according to the present embodiment.

In the second example illustrated in FIG. 15, among the plurality of cycles 1 to 7, the cycles 1 and 3 to 7 do not include a high score, but cycle 2 contains a high score. Therefore, estimation can be made that the cycle 2 has an abnormality.

Further, the scores are high in all of the plurality of sequences N1001 to N1004 included in the cycle 2. Therefore, estimation can be made that the cycle 2 has an abnormality without depending on a specific sequence.

In FIG. 15, the score data (likelihood information) is associated with the sequence information (processing identification information) and the cycle information (workpiece identification information). Alternatively, the score data may be displayed in association with only one of the sequence information and the cycle information. For example, when only the cycle 2 includes high scores as in FIG. 15, only the row of the cycle 2 may be displayed.

In the third example illustrated in FIG. 16, the score is high in all of the plurality of sequences N1001 to N1004. In addition, among the plurality of cycles 1 to 7, the score is high in all of the plurality of cycles 1 to 7. Therefore, estimation can be made that the machine 70A has an abnormality without depending on a specific sequence.

As described above, the display control unit 14 of the information processing apparatus 10 displays the plurality of sequence information and the plurality of cycle information on the information display screen 200 on the display 106a, and also displays the score on the information display screen 200 in association with each of the plurality of sequence information and each of the plurality of cycle information.

With this configuration, when the likelihood of abnormality is high in the plurality of sequences performed in the same cycle, the user can estimate that the cycle has an abnormality. By contrast, when the likelihood of abnormality is high in a specific sequence of the plurality of sequences performed in the same cycle, the user can estimate that the specific sequence has an abnormality.

Additionally, when the likelihood of abnormality is high in the plurality of cycles in which the same sequence is executed, the user can estimate that the sequence has an abnormality. By contrast, when the likelihood of abnormality is high in a specific cycle of the plurality of cycles in which the same sequence is executed, the user can estimate that the specific cycle has an abnormality.

Yet additionally, when the likelihood of abnormality is high in the plurality of sequences executed in the same cycle and the likelihood of abnormality is high in the plurality of cycles in which the same sequence is executed, the user can estimate that the machine 70A itself has an abnormality without depending on a specific sequence or a specific cycle.

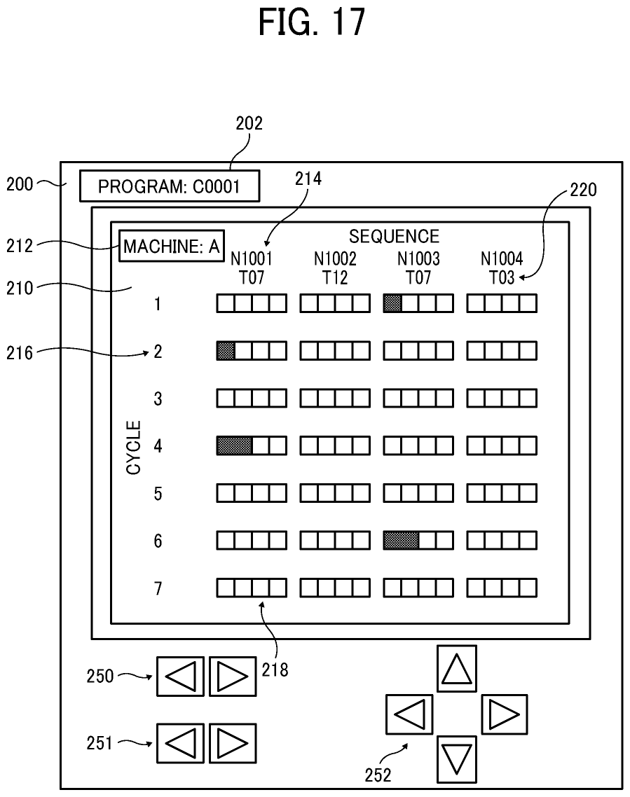

FIG. 17 is a diagram illustrating one example of an information display screen displayed on an information processing apparatus according to a first modification of the above-described embodiment.

In the information display screen 200 of the information processing apparatus 10 illustrated in FIG. 17, a tool display area 220 is added to the information display screen 200 illustrated in FIG. 13.

In this case, in step S185 illustrated in FIG. 14, among the processing information selected by the selection unit 18 in step S184, the display control unit 14 displays a plurality of sequence information in the sequence display area 214, displays a plurality of cycle information in the cycle display area 216, and displays a plurality of tool information in the tool display area 220.

Then, in step S187, among the signal data and the related data selected by the selection unit 18 in step S186, the display control unit 14 displays the score data in the score display area 218 in association with each of the plurality of sequence information, each of the plurality of cycle information, and each of the plurality of tool information.

In the modification illustrated in FIG. 17, among the plurality of sequences N1001 to N1004, the sequences N1002 and N1004 do not contain a high score, but the sequences N1001 and N1003 contain high scores. Therefore, estimation can be made that the sequences N1001 and N1003 have an abnormality.

Among the plurality of cycles 1 to 7 included in the sequence N1001, the scores are high in the cycles 2 and 4. However, this is not sufficient for estimating that the sequence N1001 has an abnormality. Further, among the plurality of cycles 1 to 7 included in the sequence N1003, the scores are high in the cycles 1 and 6. However, this is not sufficient for estimating that the sequence N1001 has an abnormality.

However, the tool display area 220 indicates that the common tool T07 is used in the sequences N1001 and N1003. Then, viewing the plurality of cycles 1 to 7 included in the sequences N1001 and N1003 together, it is known that the scores are high in four of the cycles 1 to 7, and estimated can be made that the tool T07 has an abnormality.

As described above, the display control unit 14 of the information processing apparatus 10 displays the plurality of tool information on the information display screen 200 on the display 106a, and displays the score on the information display screen 200 in association with each of the plurality of sequence information and the tool information.

With this configuration, when the likelihood of abnormality is high in a sequence using a specific tool, among the plurality of sequences performed in the same cycle, the user can estimate that the specific tool has an abnormality. By contrast, when the likelihood of abnormality is high in a plurality of cycles in which the sequence using the same tool is performed, the user can estimate that the tool has an abnormality.

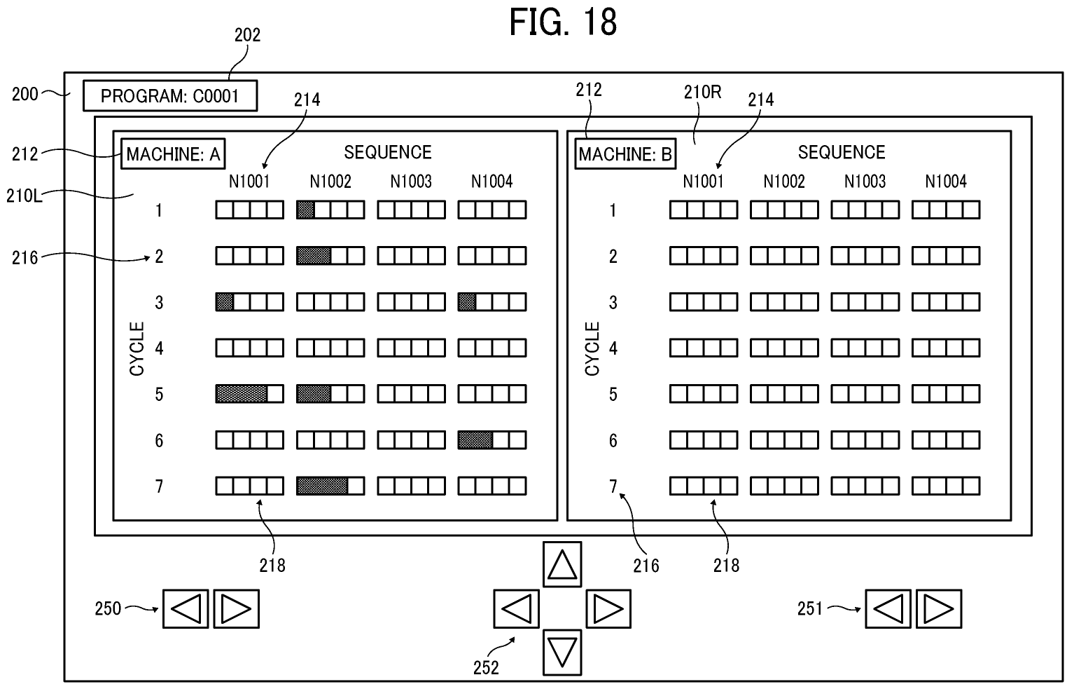

FIG. 18 is a diagram illustrating an example of an information display screen displayed on the information processing apparatus according to a second modification of the above-described embodiment.

The information display screen 200 of the information processing apparatus 10 illustrated in FIG. 18 includes a plurality of information display areas 210L and 210R. Except that, the information display screen 200 illustrated in FIG. 18 is similar to the information display screen 200 illustrated in FIG. 13.

In this case, in step S185 illustrated in FIG. 14, among the processing information selected by the selection unit 18 in step S184, the display control unit 14 displays, for each of the information display areas 210L and 210R, a plurality of sequence information in the sequence display area 214, displays a plurality of cycle information in the cycle display area 216, and displays a plurality of machine IDs in the machine display area 212.

Then, in step S187, among the signal data and the related data selected by the selection unit 18 in step S186, the display control unit 14 displays the score data in the score display area 218 in association with each of the plurality of machine IDs, each of the plurality of sequence information, and each of the plurality of cycle information.

In the second modification illustrated in FIG. 18, the information display area 210L regarding the machine ID “A” includes high scores, but the information display area 210R regarding the machine ID “B” does not include a high score. Therefore, estimation can be made that the machine 70A has an abnormality without depending on a specific sequence.

As described above, the display control unit 14 of the information processing apparatus 10 displays the plurality of machine IDs on the information display screen 200 on the display 106a, and displays the score on the information display screen 200 in association with each of the plurality of machine IDs.

With this configuration, when the likelihood of abnormality is high only in a specific machine, the user can estimate that the specific machine has an abnormality. By contrast, when the likelihood of abnormality is high in a sequence or a cycle common to a plurality of machines, the user can estimate that the sequence or the cycle has an abnormality.

As described above, the information processing apparatus 10 according to the above-described embodiment includes the detector communication unit 12 (one example of the detection result acquisition unit) configured to acquire the detection result of the physical quantity that changes as machining (an example of processing) is performed on the workpiece; the transmission and reception unit 11 (one example of the identification information acquisition unit) configured to acquire identification information for identifying each of a plurality of processes performed on the same workpiece, or each of a plurality of workpieces that are subjected to the same process; and the display control unit 14 configured to display, on the display 106a, a plurality of identification information, and display, on the display 106a, a score (an example of abnormality likelihood information) indicating the likelihood of an abnormality determined based on the detection result, in association with each identification information of the plurality of identification information.

This configuration enables the user to estimate that the workpiece has an abnormality when there is a high likelihood of abnormality in a plurality of processes performed on the same workpiece, and to estimate that the process has an abnormality when there is a high probability of abnormality in a particular process of plurality of processes performed on the same workpiece.

Alternatively, with this configuration, the user can estimate that the process has an abnormality when there is a high likelihood of abnormality in a plurality of workpieces on which the same process is performed, and can estimate that the workpiece has an abnormality when there is a high probability of abnormality in a plurality of workpieces on which the same process is performed.

The transmission and reception unit 11 acquires, as the identification information, sequence information (one example of process identification information) for identifying each of a plurality of processes performed on the same workpiece, and cycle information (one example of workpiece identification information) for identifying each of a plurality of workpieces to be subjected to the same process. The display control unit 14 of the information processing apparatus 10 displays the plurality of sequence information and the plurality of cycle information on the display 106a, and also displays the score on the display 106a in association with each of the plurality of sequence information and each of the plurality of cycle information.

With this configuration, when the likelihood of abnormality is high in the plurality of sequences performed in the same cycle, the user can estimate that the specific cycle has an abnormality. By contrast, when the likelihood of abnormality is high only in a specific sequence of the plurality of sequences performed in the same cycle, the user can estimate that the specific sequence has an abnormality.

Additionally, when the likelihood of abnormality is high in the plurality of cycles in which the same sequence is executed, the user can estimate that the specific sequence has an abnormality. By contrast, when the likelihood of abnormality is high only in a specific cycle of the plurality of cycles in which the same sequence is executed, the user can estimate that the specific cycle has an abnormality.

Yet additionally, when the likelihood of abnormality is high in the plurality of sequences executed in the same cycle and the likelihood of abnormality is high in the plurality of cycles in which the same sequence is executed, the user can estimate that the machine 70 itself has an abnormality without depending on a specific sequence or a specific cycle.

The detector communication unit 12 acquires a detection result of a physical quantity that changes with processing using a tool (an example of a processing member) on the workpiece, The transmission and reception unit 11 acquires, as the identification information, sequence information for identifying each of a plurality of processes performed on the workpiece, and tool information (one example of tool identification information) for identifying a tool type used in each of the plurality of processes. The display control unit 14 of the information processing apparatus 10 displays the plurality of tool information on the display 106a, and also displays the score on the display 106a in association with each of the plurality of sequence information and the tool information.

With this configuration, when the likelihood of abnormality is high in a sequence using a specific tool, among the plurality of sequences performed in the same cycle, the user can estimate that the sequence using the specific tool has an abnormality. By contrast, when the likelihood of abnormality is high in a plurality of cycles in which the sequence using the same tool is performed, the user can estimate that the tool has an abnormality.

The detector communication unit 12 acquires a detection result from a plurality of machines 70 (one example of the processing machine), and the transmission and reception unit 11 further acquires, as the identification information, machine IDs for identifying each of a plurality of machines (processing machine identification information). Then, the display control unit 14 displays the plurality of machine IDs on the display 106a, and also displays the score on the display 106a in association with each of the plurality of machine IDs.

With this configuration, when the likelihood of abnormality is high only in a specific machine, the user can estimate that the specific machine has an abnormality. By contrast, when the likelihood of abnormality is high in a process or a workpiece common to the plurality of machines, the user can estimate that the process or the workpiece has an abnormality.

The functions of the embodiments of the present disclosure can be implemented by a computer executable program described in a legacy programming language such as an assembler, C, C++, C#, and Java (registered trademark), or an object-oriented programming language. The program to implement the functions in each embodiment can be distributed via a telecommunication line.

The program for executing the functions of the embodiments of the present disclosure can be stored, for distribution, on a readable recording medium such as a ROM, an electrically erasable programmable read-only memory (EEPROM), an erasable programmable read-only memory (EPROM), a flash memory, a flexible disk (FD), a CD-ROM, a DVD-ROM, a DVD-RAM, a DVD-Rewritable (DVD-RW), a Blu-ray disc, a secure digital (SD) card, a magneto-optical disc (MO), and etc.

In addition, some or all of the functions of the embodiments may be mounted on a programmable device (PD) such as a field programmable gate array (FPGA) or implemented as an application specific integrated circuit (ASIC), and distributed by the recording medium as a circuit configuration data (bit stream data) downloaded to the PD in order to implement the functions of the embodiments on the PD, or as data described by Hardware Description Language (HDL), Very High Speed Integrated Circuits Hardware Description Language (VHDL), Verilog-HDL, etc., for generating circuit configuration data.

Although the information processing apparatus, the information processing method, and the program according to embodiments of the present disclosure have been described above, the above-described embodiments are illustrative and do not limit the present invention. The above-described embodiments of the present disclosure may be modified within a range that can be conceived by those skilled in the art. The modification includes additions of other embodiments, modifications, and deletions. The modifications are included in the scope of the present disclosure as long as the actions and effects of the present disclosure are provided. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general-purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol (TCP)/Internet Protocol (IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application No. 2020-044095, filed on Mar. 13, 2020, in the Japan Patent Office, the entire disclosure of which is hereby incorporated by reference herein.

### REFERENCE SIGNS LIST

1A Abnormality detection system

5 Information processing system

10 Information processing apparatus

11 Transceiver unit (Example of identification information acquisition unit)

12 Detector communication unit (Example of detection result acquisition unit)

18 Selection unit

19 Storing and reading unit (Example of storing control unit)

30A First detector

30B Second detector

50 Tool (Example of processing member)

70A First machine (Example of first processing machine)

70B Second machine (Example of second processing machine)

106a Display

173 Feature value extraction unit

175 Score calculation unit (Example of abnormality likelihood information determination unit)

200 Information display screen

700 Machining system (Example of processing system)

1000 Storage area

1. An information processing apparatus comprising:
detection result acquisition circuitry configured to acquire, for each of a plurality of processes performed on a plurality of workpieces, a detection result of a physical quantity that changes according to processing applied to a workpiece;
identification information acquisition circuitry configured to acquire process identification information identifying a particular one of the plurality of processes performed on a same workpiece and workpiece identification information identifying a particular one of the plurality of workpieces subjected to a same process; and
display control circuitry configured to:
display, on a display, the process identification information and the workpiece identification information; and
display, on the display, abnormality likelihood information indicating a likelihood of abnormality of the particular process or the particular workpiece, in association with at least one of the process identification information and the workpiece identification information,
the likelihood of abnormality having been determined based on the detection result.

2. The information processing apparatus according to claim 1, wherein the display control circuitry is configured to:
display a plurality of process identification information each identifying each of the plurality of processes and a plurality of workpiece identification information each identifying each of the plurality of workpieces; and
display the abnormality likelihood information indicating the likelihood of abnormality of the particular process on the particular workpiece in association with the process identification information and the workpiece identification.

3. The information processing apparatus according to claim 1,
wherein the detection result is a detection result of a physical quantity that changes according to processing applied to a workpiece using a tool,
wherein the identification information acquisition circuitry further acquires a plurality of tool identification information each identifying a particular one of a plurality of tools used in a particular one of the plurality of processes, and
wherein the display control circuitry is further configured to:
display the plurality of tool identification information and a plurality of process identification information including the process identification information; and
display the abnormality likelihood information indicating likelihood of abnormality of the particular process applied to the workpiece using a particular tool in association with:
a particular one of the plurality of tool identification information identifying the particular tool; and
a particular one of the plurality of process identification information identifying the particular process.

4. The information processing apparatus according to claim 1,
wherein the detection result acquisition circuitry is further configured to acquire a plurality of detection results from a plurality of processing machines,
wherein the identification information acquisition circuitry is further configured to acquire a plurality of processing machine identification information each identifying a particular one of the plurality of processing machines, and
wherein the display control circuitry is further configured to:
display the plurality of processing machine identification information on the display; and
display the abnormality likelihood information indicating likelihood of abnormality of the particular process or the particular workpiece for a particular one of the processing machines in association with:
a particular one of the plurality of processing machine identification information identifying the particular processing machine; and
the at least one of the process identification information and the workpiece identification information.

5. The information processing apparatus of claim 1, further comprising:
a memory that stores the detection result in association with each of the process identification information and the workpiece identification information.

6. The information processing apparatus of claim 1, wherein the display control circuitry is further configured to:
display the abnormality likelihood information in association with the at least one of the process identification information and the workpiece identification information.

7. An information processing method, comprising:
acquiring, for each of a plurality of processes performed on a plurality of workpieces, a detection result of a physical quantity that change according to processing applied to a workpiece;
acquiring process identification information identifying a particular one of the plurality of processes performed on a same workpiece and workpiece identification information identifying a particular one of the plurality of workpieces subjected to a same process;
displaying, on a display, the process identification information and the workpiece identification information; and
displaying, on the display, abnormality likelihood information indicating likelihood of abnormality of the particular process or the particular workpiece, in association with at least one of the process identification information and the workpiece identification information, the likelihood of abnormality having been determined based on the detection result.

8. A non-transitory computer readable medium including computer readable code for controlling a computer to carry out the method according to claim 7.
